(19) United States
(12) Patent Application Publication
(10) Pub. No.: US 2011/0198258 A1
(43) Pub. Date: Aug. 18, 2011

(54) RECLOSEABLE COMESTIBLE PACKAGING

(75) Inventor: Allen Aldridge, South Orange, NJ (US)

(73) Assignee: CADBURY ADAMS USA LLC, Parsippany, NJ (US)

(21) Appl. No.: 12/674,590

(22) PCT Filed: Aug. 22, 2008
(86) PCT No.: PCT/US08/10015

§ 371 Date: Apr. 5, 2010

Related U.S. Application Data
(60) Provisional application No. 60/957,553, filed on Aug. 23, 2007.

(51) Int. Cl. B65D 85/00; B31B 3/00

(52) U.S. Cl. 206/524.1; 493/162

(57) ABSTRACT

A package includes a package housing defining an interior for accommodating consumable products. The housing includes a back wall having opposed edges. A first flap extends from one of the opposed edges of the back wall and overlies a housing front wall portion. A second flap extends from the other of the opposed edges of the back wall forming a cover. The cover is movable between an open and closed position to selectively cover and uncover the interior. The first flap forms a securement element for receiving therein a portion of the second flap for securing the cover in a closed position.

This application claims priority to U.S. Provisional Patent Application No. 60/957,553 filed on Aug. 23, 2007, the entire disclosure of which is incorporated by reference herein.

### FIELD OF INVENTION

The present invention relates generally to a package for containing an array of consumable products and retaining the products in the package until such time as the individual products are desired to be removed. Particularly, the present invention relates to a package assembly for providing reclosable covering for a package of discrete gum slabs.

### BACKGROUND OF THE INVENTION

Chewing gum is currently available to consumers in a variety of different formats. These include stick gum, slab gum, pellet gum, extruded gum, and others. A variety of types of gum packaging exist, including certain types of packaging used predominately for one or the other of the gum formats. Slabs of gum have often been sold in foil packages. Originally, these slabs were arranged in a package in a side-to-side manner, perhaps including five to seven slabs per package. More recently, these slabs have been arranged within the foil packages in a face-to-face manner, allowing slabs to be contained in a convenient package. Slabs have also been packaged in paperboard packaging which can be repeatedly opened and closed.

Such packaging is currently popular and achieves satisfactory results. It has been discovered, however, that the previous approaches have certain drawbacks. These drawbacks relate to the lack of a suitable means for closing the package once it has been opened. In packaging including foil, typically a portion of the foil packaging is torn off to allow access to the slabs. The package may then be stored or placed in a purse, jacket, or pants pocket. While stored in this manner, some of the slabs may fall out of the package. Also, while stored in this manner it is very possible for foreign material, such as lint, dirt, and so forth, to enter the package. Subsequently, when the package is retrieved from the purse or pocket, some of the slabs may have slipped out of the package and be loose in the purse or pocket. Also, the package may not look appealing once retrieved from the purse or pocket, due to foreign material that may have entered or adhered to the package.

Packaging closures including paperboard may also include slits formed through panels of the package with a portion of the cover extending through the slit. However, such slits tend to rip as the package is repeatedly opened and closed. Once ripped, the slit widens and no longer adequately retains the cover in the closed position.

Accordingly it would be desirable to provide a product package for containing an array of gum slabs that can be opened to remove the desired product and reclosed to retain the remaining gum slabs.

### SUMMARY OF THE INVENTION

The present invention provides a package including a housing and cover repeatedly securable in a closed position.

The present invention further provides a reclosable package including a securement element formed by overlying panels for receiving a portion of the cover.

The present invention also provides a package including a package housing defining an interior for accommodating consumable products. The housing includes a back wall having opposed edges, a first flap extending from one of the opposed edges of the back wall and overlying a housing front wall portion, and a second flap extending from the other of the opposed edges of the back wall forming a cover. The cover is movable between an open and closed position to selectively cover and uncover the interior. The first flap forms a securement element for receiving therein a portion of the second flap for securing the cover in a closed position.

The present invention still further provides a comestible package housing including a first and second wall defining a package interior. A cover extends from the second wall and is movable between an open and closed position. The first wall includes a pair of overlying wall portions forming a slot therebetween. The slot is configured to receive therein a portion of the cover. The slot retains the cover in the closed position.

The present invention still further provides a method of forming a comestible package including the steps of:

forming a blank, the blank including a first panel and a second panel extending laterally from the first panel, the first panel including a first flap and a second flap;

folding the second panel over the first panel such that it is in opposed relation to the first panel to form a package interior;

securing the second panel to the first panel; and

folding the first flap over the second panel and securing the first flap to the second panel to form a slot, the slot being configured to receive a distal end of the second flap.

### BRIEF DESCRIPTION OF THE DRAWINGS

FIG. 1 shows a packaging of the present invention in an initial closed position.

FIG. 1A shows the packaging of FIG. 1 with a cover in an unsecured position.

FIG. 2 shows the packaging with the cover in an open position.

FIG. 2A shows the packaging of FIG. 2 with a comestible being removed.

FIG. 3 shows the packaging with the cover moved to the closed position.

FIG. 3A shows the packaging of FIG. 3 with the cover in a secured closed position.

FIG. 4 is a partial cross-sectional view taken along line 4-4 of FIG. 3A.

FIG. 5 is a top plan view of the packaging of FIG. 2 with the comestibles removed.

FIG. 6 shows a top plan view of a blank used to form the packaging of FIG. 1.

FIG. 7 shows a perspective view of an alternative embodiment of a packaging of the present invention.

FIG. 8 shows a top plan view of a blank used to form a further alternative embodiment of a packaging of the present invention.

FIG. 9 shows a perspective view of an alternative embodiment of a packaging of the present invention.

FIG. 10 shows a perspective view of an alternative embodiment of a packaging of the present invention used with a blister pack.

FIG. 11 shows a top plan view of a blank used to form the packaging of FIG. 10.

### DETAILED DESCRIPTION OF THE PREFERRED EMBODIMENTS

The present invention is directed to a package assembly which contains a plurality of consumable products in a package housing. The package housing may be opened to allow dispensing of one or more products therefrom and can be reclosed to maintain the products therein. While the present invention is useful with a wide of variety of consumable products, it is particularly useful with respect to elongate gum slabs which are arranged in an array.

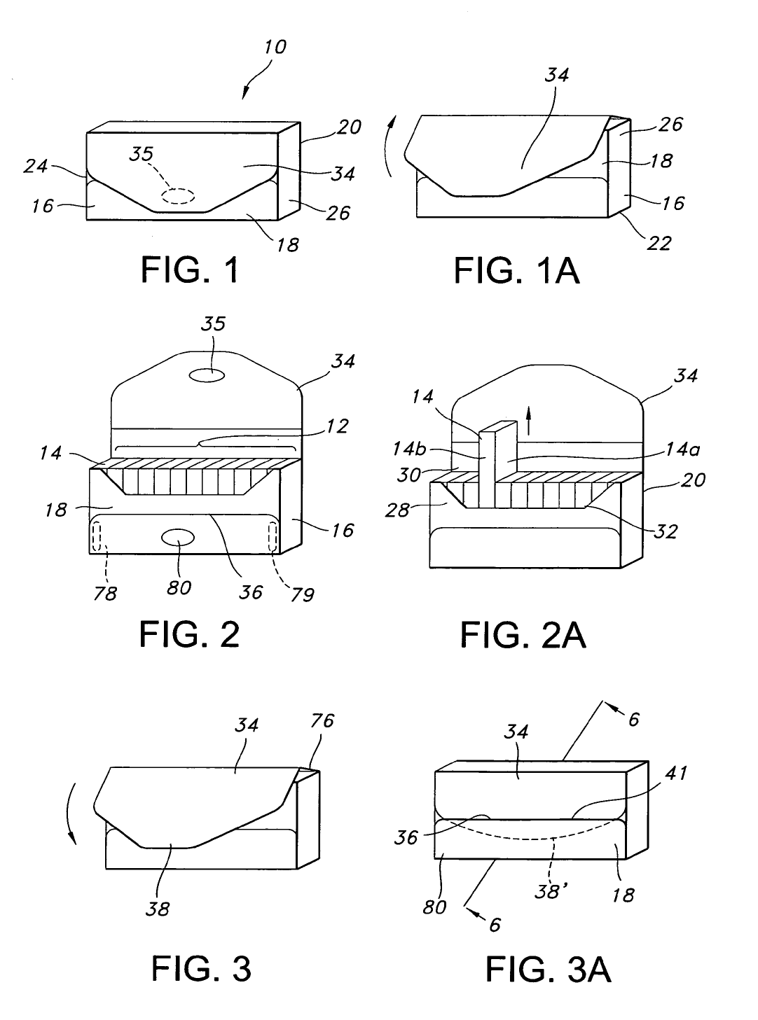

Referring now to FIGS. 1-2A, the present invention provides a packaging assembly 10 which supports and retains therein products such as an array 12 of discrete gum slabs 14. Gum slabs 14 are typically elongate, rectangularly-shaped members having face surfaces 14a and side edges 14b. Gum slabs may optionally include wrappers (not shown in FIG. 2) individually around each gum slab. The gum slabs may be arranged in a face-to-face fashion to form array 12 as shown in FIGS. 2 and 2A. Alternatively, the slabs 14 could be arranged in a side edge-to-side edge manner (not shown). The gum slabs 14 are supported in the array in a package housing 16. It is within the contemplation of the present invention that a plurality of gum slab arrays may be supported in the package housing in the form of multiple rows.

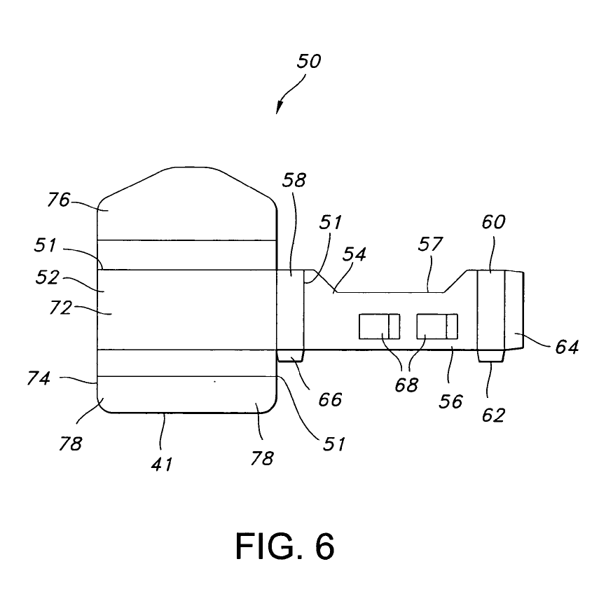

The package housing 16 may include a front wall 18, an opposed back wall 20, a bottom wall 22, and opposed side walls 24 and 26. The use of the terms front, back, and side is for descriptive purposes and is not intended to be limiting. With specific reference to FIG. 2A, the package housing 16 provides an open upper end 28 which defines a dispensing opening 30 which leads to a package interior 32 wherein the gum slabs 14 are contained. The back wall 20 has extending upwardly therefrom a cover 34 which may be folded over the open upper end to close the opening 30 and contain the slabs 14 within the package housing 16. As will be described in further detail with reference to FIG. 6, the package housing 16 is preferably formed from die cut paperboard, which is to form the configuration shown, for example, in FIG. 1.

It is also contemplated that the package housing 16 may be covered by a removable plastic wrap (not shown) which encloses and protects the package housing during shipping and prior to sale and use.

With reference to FIG. 1, cover 34 may be retained in an initial closed position by one or more adhesive portions 35 which secure the cover 34 to the front wall 18. Adhesive portion 35 may be located on the packaging housing 16 at any point in which the cover 34 overlies a portion of the package housing. A user may pull the cover 34 away from the front wall 18 and overcome the adhesive, whereby the cover 34 may be rotated to an unsecured closed position shown in FIG. 1A. The cover 34 may then be further rotated upwardly to the open position shown in FIG. 2. The array of gum slabs 12 is then exposed and a piece of the gum may be removed (FIG. 2A). After a piece of gum is removed, the cover 34 may then be rotated downwardly to the unsecured closed position shown in FIG. 3.

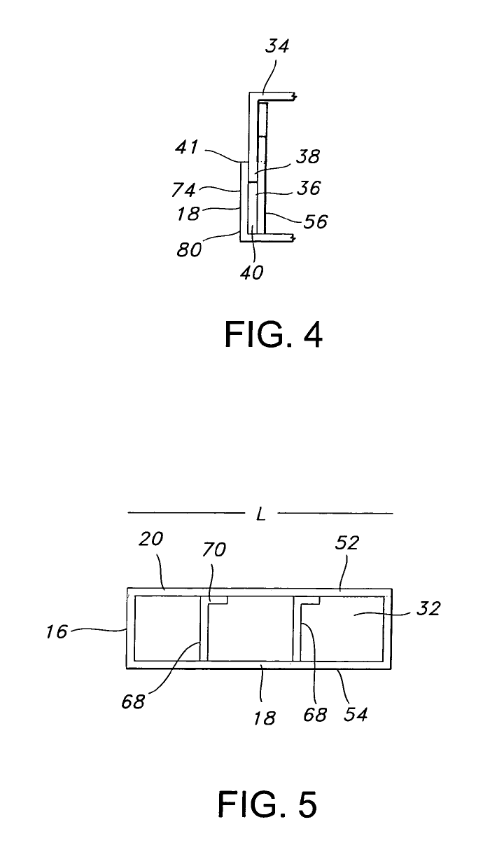

With reference to FIGS. 3A and 4, the front wall 18 may include a securement element 36 for retaining the cover 34 in the closed position. The cover distal end may form a cover tab 38, 38′ which cooperates with the securement element 36. It is within the contemplation of the present invention that the cover tab may be formed in a wide variety of configurations, as shown, for example, in FIGS. 3 and 3A. Preferably, the securement element 36 may include a pocket-like slot 40 disposed at a position on the front wall 18 to receive the cover tab 38, 38′. Slot 40 may be formed on the front wall 18 by two panels which overlie each other. Further description of the securement element 36 is set forth below.

Adhesive portion 35 used to initially hold the cover 34 in a closed position may be located such that it is obstructed from view when the cover 34 is closed and tucked into the slot 40. Therefore, any negative aesthetic impact caused by the adhesive portion 35 is overcome. In an alternative embodiment, the adhesive portion 35 may be eliminated, and the cover may be held in an initial closed position by the outer plastic wrap.

With additional reference to FIG. 5, package interior 32 may include one or more support tabs 68 disposed therein. Support tabs 68 may extend between front wall 18 and back wall 20 and are spaced from each other along a length, L, of the package housing 16. The support tabs 68 may each have a distal foot-like portion 70 that lies flat against the back wall 20 and is adhered thereto. Alternatively, the foot-like portions may be secured to the front wall 18. The support tabs 68 resist movement between the front wall 18 and the back wall 20, such that the walls do not freely collapse toward each other. The support tabs 68 strengthen the package housing 16 and protect the comestibles within. The support tabs 68 also divide the package interior 32 into separate sections which helps to maintain the gum slabs 14 in an upright orientation.

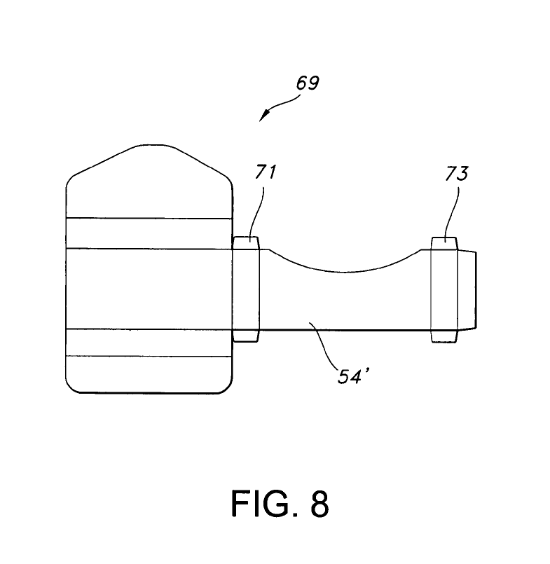

Referring now to FIG. 6, the package housing 16 may be formed of a blank 50. In a preferred embodiment blank 50 is a unitary structure and permits the package housing 16 to be formed from one unitary structure. The package housing blank 50 may be formed from a die cut paperboard form which may be folded from its flat configuration shown in FIG. 6 into the configuration shown in FIGS. 1-2A. Various panels of the blank 50 may be folded along preformed fold lines 51 in order to form the package housing 16. The blank 50 includes a back panel 52 and a front panel 54 extending laterally from a side of the back panel 52. The front panel 54 includes the front wall panel 56 which is bounded along its sides by the side wall panels 58 and 60. First and second securement tabs 62 and 64 extend from the side wall panel 60. A further securement tab 66 extends from side wall panel 58. In forming the package housing 16, the front panel 54 is folded over the back panel 52 such that the front wall panel 56 is in opposed relation to back panel 52. The securement tabs 62, 64, and 66 may be secured to the back panel 52 by adhesive in forming the package housing 16. Alternatively, tabs 62 and 66 may be folded inwardly such that they overlie each other but are not secured by an adhesive. The front wall panel 56 may include a top edge 57 which dips downwardly to form a notched recess to provide greater access to the comestibles. It is within the contemplation of the present invention that the top edge 57 could be formed in a variety of configurations including generally U-shape configurations as shown in FIGS. 2 and 8. The top edge 57 could be formed in other configurations and the present invention is not limited to the embodiments shown.

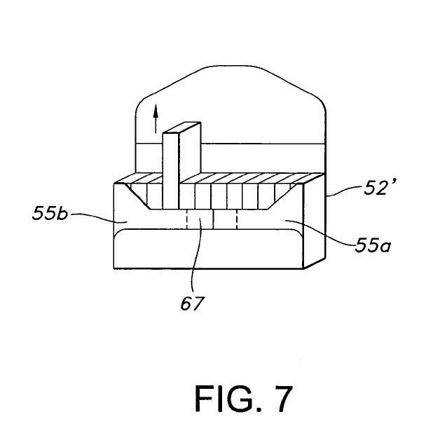

In an alternative embodiment as shown in FIG. 7, front panel may include two portions with one portion 55a extending from one side of back panel 52′ and the other portion 55b extending from the other side of the back panel 52′. The front panel portions 55a and 55b may join together upon forming the packaging. Alternatively, upon forming the package the front panel portions may not join each other but be separated by a space 67 as shown in phantom lines in FIG. 7.

In a further alternative embodiment as shown in FIG. 8, blank 69 may include additional tabs 71 and 73 extending from a front panel 54′. Tabs 71 and 73 may be folded over to extend under the cover when in the closed position. The remaining panels of blank 69 may be folded in a similar manner as set forth above with respect to blank 50 of FIG. 6.

With additional reference to FIGS. 5 and 6, a portion of the front wall panel 56 may be used to form the support tabs 68 by punching or die cutting a portion of the front wall panel 56 to create the support tabs. The cut portion may be folded in a position generally perpendicular to the front wall panel. When the front panel 54 is folded in opposed relation to the back panel 52, the support tabs 68 engage the back wall panel as shown in FIG. 5. Accordingly, the support tabs 68 may be integrally formed with the other elements of the package housing.

With reference to FIGS. 2 and 6, the back panel 52 includes a back wall panel 72 having opposed edges. A first flap 74 extends from one of the opposed edges and a second flap 76 extends from the other opposed edge. As shown in FIGS. 2 and 4, the first flap 74 is folded upwardly and over a portion of the front wall panel 56. The first flap 74 is partially secured to the front wall panel 56 to form the front wall 18. The holes formed in the front wall panel 56 caused by the formation of the support tabs 68 may be covered by the first flap 74. Accordingly, the front wall 18 is preferably formed by the front wall panel 56 and the first flap 74. The first flap 74 is preferably secured at its side ends 78 by adhesive 79 (FIG. 2) to the front wall panel 56. Alternatively, securement devices other than adhesive could be used. An unsecured portion 80 of the first flap between the adhered ends is preferably not adhered to the front wall panel 56. The second flap 76 forms the cover 34 and is folded over as shown in FIG. 3 to cover the dispensing opening 30 of the package housing 16.

In order to assemble the blank 50 into the package housing 16, various portions of blank 50 are folded and portions are adhered to each other in a manner known in the art. In order to simplify production, it is preferable that the adhesive be applied to one side of the blank 50. Alternatively, it is within the contemplation of the present invention that the adhesive could be located on both sides of the blank.

While in the preferred embodiment, the package housing 16 is described as being integrally formed by a one piece blank. It is within the contemplation of the present invention that the package housing could be formed of multiple pieces secured together.

As noted above, the cover tab 38 is inserted into the securement element 36 to retain the cover 34 in the closed position. The securement element 36 may be a pocket-like structure formed on the exterior of the package housing and is separate from the package interior 32. With reference to FIGS. 3A, 4, and 6, the securement element 36, which includes slot 40, is formed by and between the first flap 74 and the front wall panel 56 which overlie each other. The opening of the slot 40 is formed at the distal edge 41 of the first flap. Preferably, the slot is formed between the first flap unsecured portion 80 and the front wall panel 56. Accordingly, the length of the slot 40 is defined by an extent of the first flap which is unsecured to the front wall panel 56. The cover tab 38, 38′ may be inserted into the slot 40 for reclosing the package housing 16 as shown in FIGS. 3A and 4. When the cover 34 is in the closed position, the tab 38, 38′ extends below the distal edge 41 of the first flap. Distal edge 41 may be disposed between the package housing bottom wall 22 and the front wall panel top edge 57. Accordingly, when the tab 38, 38′ is tucked into the slot 40, it remains in the slot when the cover is closed. In addition, due to the overlying nature of the first flap 74 and front wall panel 56 the flap and panel tend to urge against the cover tab 38 when placed in the slot 40, thereby assisting in retaining the cover tab in the slot. The cover 34 may be opened by moving the tab 38, 38′ upwardly so that it exits slot 40. The cooperation between the cover 34 and slot 40 permit the cover to be repeatedly opened and closed by a user.

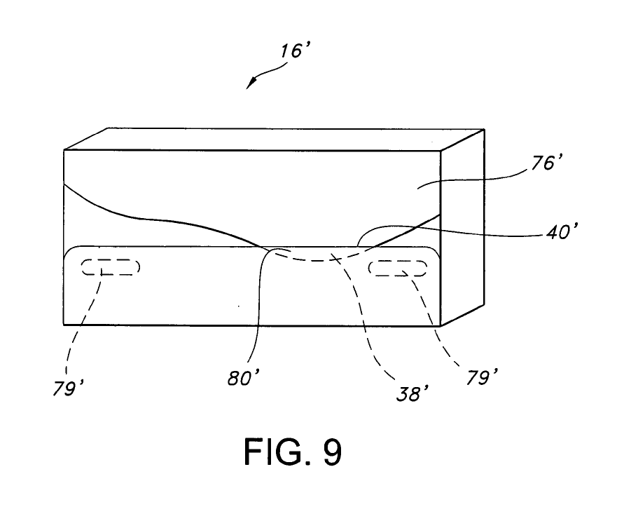

In the embodiment shown in FIG. 1, the first flap unsecured portion 80 is and slot 40 formed thereby are generally centrally located along the length of its distal edge, and the tab 38 is centrally located along a distal edge of the second flap 76. The cover tab 38 may be formed in a variety of shapes and located at differing locations on the cover. For example, in an alternative embodiment shown in FIG. 9, package housing 16′ includes an unsecured portion of the first flap 80′ bounded by adhesive 79′. Unsecured portion 80′ and slot 40′ formed thereby is generally asymmetrically located along the length of its distal edge. The cover tab 38′ is asymmetrically located along a distal edge of said second flap 76′ such that it is aligned with the unsecured portion 80′ and insertable into slot 40′.

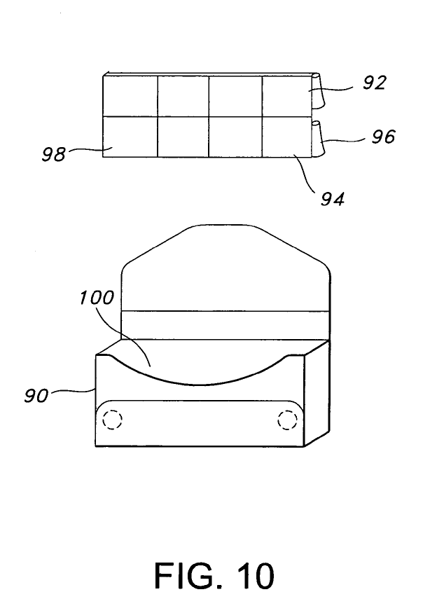

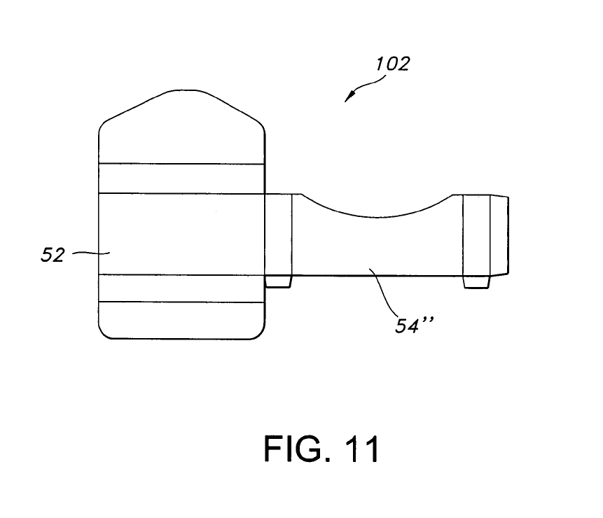

With reference to FIG. 10, in an alternative embodiment, the package housing 90 may also be configured to accommodate comestible material that is retained in internal packaging such as a blister pack 92. The blister pack may be formed in a manner well known in the art. The blister pack 92 may include a flexible tray 94 including a plurality of depressions 96 for holding the comestible. The tray 94 may then be covered by a frangible member 98, such as one made of foil. The member 98 is frangible above the depressions 96 so that the comestible may be pushed out through the member. The blister pack 92 may be inserted in and out of the package interior 100 as desired. In this embodiment, support tabs may not be included in order to permit clearance for the blister pack 92 to be inserted into the package interior. With reference to FIG. 11, the blank 102 for forming the package housing 90 may be similar to the blank 50 described above with respect to FIG. 6, except for not including the support tabs on the front wall panel 54″. It is also within the contemplation of the present invention that the comestibles may be held in other types of internal packaging.

The packing described herein has been shown in the form of a generally rectangular shape. However, it is within the contemplation of the present invention that the package could be formed in a variety of shapes, and the invention is not restricted to the shape which is shown.

Although the above-described packaging design has been described in conjunction with slab gum, it could also be adapted to work for stick gum, extruded gum, pellet gum, and candy-coated gum. The packaging could also be used to hold a singular unitary product as opposed to various pieces. Furthermore, the packaging design described herein could be used to hold other types of consumable products or other products.

Having described the preferred embodiments herein, it should now be appreciated that variations may be made thereto without departing from the contemplated scope of the invention. Accordingly, the preferred embodiments described herein are deemed illustrative rather than limiting the true scope of the invention being set forth in the claims appended hereto.

What is claimed is:

1. A package comprising:
a package housing defining an interior for accommodating consumable products;
said housing including a back wall having opposed edges, a first flap extending from one of said opposed edges of said back wall and overlying a housing front wall portion, and a second flap extending from the other of said opposed edges of said back wall forming a cover, said cover being movable between an open and closed position to selectively cover and uncover said interior; and
said first flap forming a securement element for receiving therein a portion of said second flap for securing said cover in a closed position.

2. A package of claim 1, wherein said first flap is partially secured to said front wall portion, said first flap and said front wall portion defining therebetween said securement element.

3. A package of claim 2, wherein said first flap is partially adhesively secured to said front wall portion and wherein said securement element is defined by an extent of said first flap which is unsecured to said front wall portion.

4. A package of claim 1 wherein said housing interior supports a blister tray containing said consumable products.

5. A package of claim 1, wherein said housing interior supports said consumable product in an array of individual pieces.

6. A package of claim 3, wherein said cover includes a distal end being insertably received in said securement element.

7. A package of claim 6, wherein said unsecured location of said first flap is centrally located along said front wall portion, and wherein said cover includes a tab centrally located along said distal edge of said cover.

8. A package of claim 6, wherein said unsecured insertion location of said first flap is asymmetrically located along said front wall portion, and wherein said cover includes a tab asymmetrically located along said distal edge of said cover.

9. A package of claim 1, wherein said package housing is formed from a flat blank folded into said package housing.

10. A package of claim 1, wherein said housing front wall portion is disposed in opposed relation to said back wall and said first flap is partially secured to said front wall portion.

11. A package of claim 10, wherein said securement element includes a slot defined between said first flap and said front wall portion.

12. A package of claim 1, wherein said package housing is formed from a single unitary structure.

13. A package of claim 1, wherein said package housing interior includes at least one support tab extending between said front wall portion and said back wall.

14. A package of claim 1, further including a plurality of comestible pieces.

15. A comestible package housing comprising:
a first and second wall defining a package interior;
a cover extending from said second wall and movable between an open and closed position; and
said first wall including a pair of overlying wall portions forming a slot therebetween, said slot configured to receive therein a portion of said cover, said slot retaining said cover in said closed position.

16. A package housing of claim 15, wherein said first wall includes a first panel and a flap partially adhered thereto, said first panel and said flap form said pair of overlying wall portions.

17. A package housing of claim 15, wherein said flap extends from said second wall.

18. A package housing of claim 16, wherein a portion of said flap forms a bottom wall.

19. A method of forming a comestible package comprising the steps of:
forming a blank, the blank including a first panel and a second panel extending laterally from the first panel, the first panel including a first flap and a second flap;
folding the second panel over the first panel such that it is in opposed relation to the first panel to form a package interior;
securing the second panel to the first panel; and
folding the first flap over the second panel and securing the first flap to the second panel to form a slot, the slot being configured to receive a distal end of the second flap.

20. A method of claim 19 further including the steps of forming a support tab from the blank and securing it between the first and second walls.

21. A method of claim 19 wherein the first flap includes a portion forming a bottom wall of the package.

22. A method of claim 19 further including the step of folding the second flap over the second panel to cover the package interior.

23. A method of claim 19 further including the step of providing an unsecured portion between the first flap and the second panel, the unsecured portion defining an extent of the slot.
